(19) United States
(12) Patent Application Publication
(10) Pub. No.: US 2002/0174177 A1
(43) Pub. Date: Nov. 21, 2002

(54) Voice activated navigation of a computer network

(76) Inventors: Sharon Miesen, McKinney, TX (US); David Lau, Dallas, TX (US)

Correspondence Address: Slater & Matsil, L.L.P., Suite 1000, 17950 Preston Rd., Dallas, TX, 75252-5793, US

(21) Appl. No.: 09/841,848

(22) Filed: Apr. 25, 2001

(51) Int. Cl. G06F 15/16

(52) U.S. Cl. 709/203

(57) ABSTRACT

Wireless access to a computer network, such as the Internet and its associated World Wide Web resources, is greatly simplified using a voice driven system in which specific Web pages are identified using spoken shortcut phrases, which phrases are converted into text commands and compared to a database of stored bookmarks. When a matching bookmark is located, it is sent to a Web server which will serve up the resource to the wireless access device, such as a cellular telephone or personal digital assistant. Preferably, the wireless access device can maintain a voice channel to a speech server for providing spoken shortcuts, while at the same time maintaining a data channel to the Web server for receiving the requested Web pages. In other embodiments, the spoken command is provided over a voice connection, which connection is terminated in order to allow the requested page to be served over a data connection. In yet other embodiments, a data connection is established first and a hyperlink to a speech server is provided; when the speech server is selected, the data connection is suspended while a voice connection with the speech server is established and the spoken shortcuts are provided.

This application is related to co-pending, commonly assigned provisional patent application filed concurrently herewith and entitled Voice Activated Wireless Locator Service, which provisional patent application is hereby incorporated by reference.

### FIELD OF THE INVENTION

The invention relates to navigation of a computer network using a wireless access device, and more particularly to using voice recognition to select from among a plurality of available resources on a computer network, such as World Wide Web pages on the Internet.

### BACKGROUND OF THE INVENTION

Two of the most rapidly growing and developing areas of technology today are wireless communications and the Internet. Not surprisingly, these two technologies are experiencing a rapid convergence, much as wire-based telephony and personal computers converged in the 1990's and continue to do so today.

One of the primary motivating factors behind the convergence of wireless telephony and Internet technology is the ubiquitous presence of the World Wide Web in all facets of society. E-mail, e-commerce, entertainment, business-to-business commerce, and many other resources are commonly available as World Wide Web resources. Not surprisingly, consumers desire to have such resources be as convenient and mobile as are today's hand-held devices, such as cellular telephones and personal digital assistants (PDA's). Because the Internet and World Wide Web developed based upon wire-based telephony and relatively powerful computers, several technological hurdles must be overcome before the World Wide Web can be accessed from a wireless device with sufficient ease and convenience to make the Web a truly wireless resource.

One shortcoming in a typical current wireless access device is the limited means for inputting data, such as the uniform resource indicator (URI) of a desired Web resource. Whereas the typical Web user uses a personal computer (PC) with a mouse and keyboard for inputting information such as the address, or URI, of a Web page, a wireless access device user generally must rely upon a cumbersome and tedious process of inputting a URI one letter at a time using the limited keypad capabilities of a typical cellular telephone or PDA. This is because cell phone and PDA's were developed to provide other functions, and were not originally intended for the type of data input intensive operations Web browsing often entails.

The shortcomings of wireless access devices are exacerbated by the fact that such devices are typically used when the end-user is outside of his or her home, oftentimes engaged in other activities such as walking or driving. Under those circumstances, it is most undesirable that the user be distracted from the primary task (such as driving) in order to tediously input a URI one letter at a time.

One attempted solution to the problem of navigating the Web from a wireless access device is the use of a home page or entry portal that provides a menu or listing of several hyperlinks, each hyperlink being a simple representation of a particular Web page's URI, or network address. The user can simply scroll down the list until a desired Web page is highlighted and select that hyperlink. This solution is quite limited, however, in that only those Web pages that are included on the list are easily accessible. Most wireless access devices have limited display capabilities, and hence only a few hyper-links would be displayed at a time. The user would need to scroll down perhaps several screens to find a desired page and once more than a dozen or so pages are included on the list, the list itself becomes quite bulky and difficult to use. Also, such a solution requires that a third party, typically the wireless access service provider, maintain the list, which list is provided to all users. As such, many Web pages on the list will be of no interest to any given user, whereas other Web pages of interest to a given user will not be included.

Therefore, a need exists for a system and method whereby World Wide Web resources, as well as other resources available over the Internet or some other computer network, can be easily accessed using the functionality provided in a typical wireless access device.

### SUMMARY OF THE INVENTION

In one aspect, the invention provides for a method of providing voice activated computer network navigation to an end-user using a wireless access device. The method includes initiating a data connection between the wireless access device and a wireless access server, and serving a Web page to the wireless access device over the data connection, the Web page including one or more hyper-links, one of said hyper-links linking to a pre-selected speech server. In response to an end-user clicking on the one of said hyper-links, a voice connection is initiated between the wireless access device and the preselected speech server. The method further includes providing an interactive voice response session over the voice connection between the speech server and the wireless access device, whereby voice prompts are provided to the end-user and the end-user's voice responses are provided back to the speech server, performing a speech to text conversion on a user's spoken command, the converted command indicating a desired resource, forwarding the converted command from the speech server to the wireless access server; and serving the desired resource to the wireless access device over the data connection.

In another aspect, the invention provides for a system for voice driven navigation of a computer network, the computer network having a plurality of network resources, each such resource having associated with it a unique resource identifier, comprising a wireless access device, a wireless switch configured to receive transmissions from the wireless access device and to forward the transmissions to a public switched telephone network, and a speech server coupled to the public switched telephone network, configured to receive voice commands contained in the transmissions from the wireless access device and to convert the voice commands into text commands. The speech server is configured to retrieve from a database a resource indicator matching the converted text command and to forward the retrieved resource indicator to a wireless access server. The wireless access server is coupled to the speech server, and is configured to retrieve the resource associated with the resource indicator and to serve the resource to the wireless access device.

In yet another aspect, the present invention provides for a speech server configured to provide voice driven access for navigation of a computer network. The computer network includes a plurality of resources, each such resource having a network address associated with it. The speech server includes a call manager coupled to a telephone network and configured to receive an incoming voice call initiated from a wireless calling device, a speech to text converter coupled to the call manager, receiving as input a spoken phrase associated with a desired network address and converting the spoken phrase into a text command, a comparator, coupled to the speech to text converter and configured to compare the text command to entries stored in a network address database, and a network connection coupled to the computer network and configured to forward a selected network address from the network address database to a computer network server, whereby the computer network server will serve up the resource associated with the selected network address to the wireless calling device.

### BRIEF DESCRIPTION OF THE DRAWINGS

FIG. 1 illustrates in block diagram format a preferred embodiment system for providing voice driven navigation of a computer network, such as the Internet.

FIG. 2 illustrates in block diagram format a preferred embodiment speech server and associated components.

### DETAILED DESCRIPTION OF THE PREFERRED EMBODIMENTS

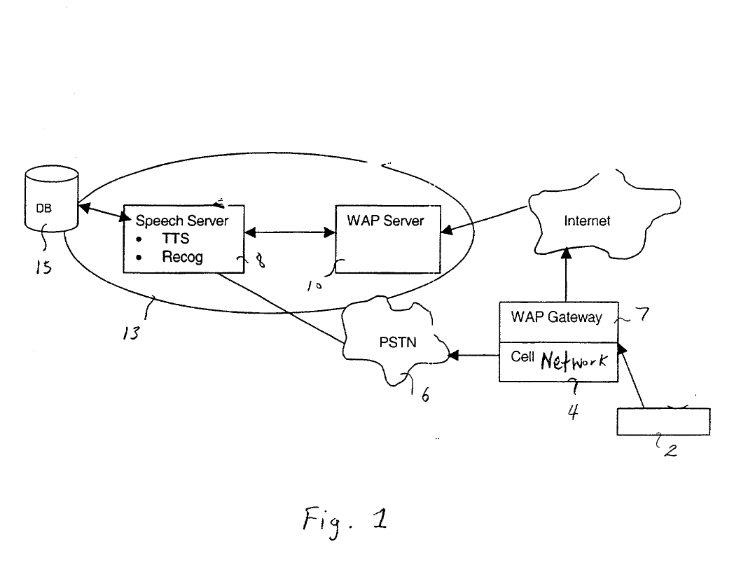

A first preferred embodiment system and method will be described with reference to FIG. 1. The system, referred to generally as 100, includes a wireless access device 2, which is preferably a Wireless Access Protocol (WAP) compatible cellular telephone handset, such as the Motorola IDEN “plus” WAP phone available from Motorola Corp., Schaumburg, Ill. Cellular phone 2 runs a WAP compatible browser, specially configured for the limited memory and storage capabilities of a cellular phone, such as the UP Browser available from OpenWave Systems, Inc. of Redwood City, Calif. Alternatively, wireless access device 2 could be a personal digital assistant (PDA), such as a Palm Pilot VII, available from Palm Computing, configured to include a WAP Web browser and cellular or wireless communication capabilities. For clarity, wireless access device 2 may be referred to as a cellular phone in the following description, even though other embodiment devices, such as PDA's and Internet appliances are also contemplated.

As illustrated, wireless access device 2 is preferably configured to transmit either “data” or “voice.” In practice, both “data” and “voice” are transmitted as analog or digital signals using similar radio frequency modulation and communication schemes. The difference between data and voice is the protocol used in handling the received signal at the other end. “Data” communications will be de-modulated and treated as digital information, whereas “voice” communications will be de-modulated, then passed to a digital-to-analog converter (DCA) to re-create a voice signal.

Voice communications are transmitted over a cellular service provider network 4 to the public switched telephone network (PSTN) 6 and thence to the desired destination (as indicated by the telephone number dialed). In the illustrated case, the desired destination is a speech server 8, for which additional details will be provided below.

Data communications will also be transmitted from wireless access device 2 through cellular service provider network 4 and then to a WAP gateway 7, which serves as a sort of translator and border crossing between the wireless communications network 4 and the Internet 12. WAP gateway 7 accepts incoming WAP messages in cellular transmission protocol and forwards those requests onto the Internet using TCP/IP protocol. Likewise, WAP messages originating on the Internet will be passed on to cellular service network 4 by the WAP gateway. Once carried by TCP/IP network protocols, the requests from wireless access device 2 can be transmitted over the Internet 12 to a specified destination, such as WAP server 10.

In the preferred embodiments, WAP server 10 provides standard Web server functionality, such as receiving incoming requests for resources and serving up Web pages or other Web resources in response. A preferred example of such a server is Microsoft IIS, available from Microsoft Corp., Redmond, Wash. The server can run on a x86 based platform, such as a Dell Pentium based Server, available from Dell Computer Corp., Austin, Tex.

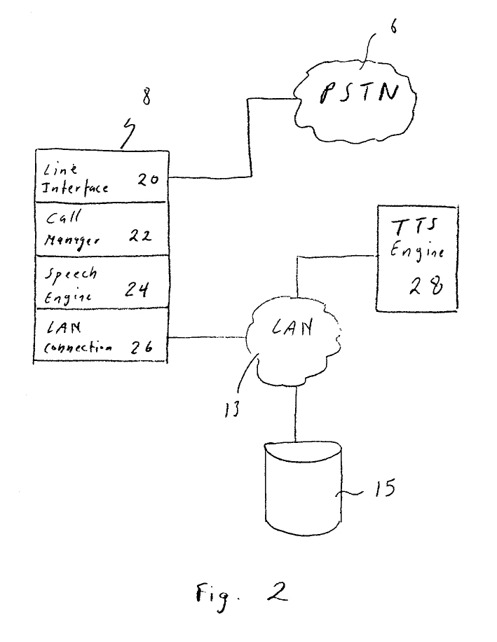

Further details will now be provided regarding speech server 8 with reference to FIG. 2. As shown, speech server 8 includes a line interface 20, a call manager 22, a speech recognition engine 24, and a Local Area Network (LAN) connection 26. Speech server 8 is preferably an x86 based workstation, such as a Pentium based Alliance computer.

Line interface 20 provides interface between speech server 8 and the public switched telephone network 6. An exemplary line interface card is the D/41 available from Dialogic Corp., which provides four ports for incoming calls. In commercial embodiments, greater call handling capacity would be preferable.

Call manager 22 operates as a manager and arbitrator of resources for incoming calls and outgoing responses, as will be described in greater detail below. Speech recognition engine 24 is preferably a Nuance 6.2.2 speech recognition engine, available from Nuance Corporation. Finally, LAN connection 26 provides interface between speech server 8 and other components also connected to a LAN 13 (FIG. 1), such as WAP server 10 and also TTS engine 28. TTS engine 28 is preferably a Lernout & Hauspie, Inc. “RealSpeak” TTS product. In other embodiments, TTS engine 28 can run on the same computer and be considered as part of speech server 8. Preferably, however, the TTS engine runs on a separate computer in order to provide for quicker response times and to mitigate the effects of competition for computer resources.

WAP server 10 can access resources using the Internet 12, including specific World Wide Web pages, such as exemplary page 14. As is known to one skilled in the art, World Wide Web resources are identified and located by use of a uniform resource indicator (URI), each Web page having a unique URI associated with it. A typical URI may be of the form “http://www.wirenix.com.” For convenience, most desk-top Web browsers provide a “bookmark” function whereby a Web page's URI can be stored in a convenient form on the desktop, such as a drop down menu. When the user desires to access that Web page again, the user can simply select the book mark from the drop down menu, rather than typing in the entire URI manually. Typically, the drop down menu does not list out the entire URI, but rather displays a simple, readily recognizable short cut phrase associated with the Web page. In the example given above, the short cut phrase might be simply “wirenix” or perhaps, “wirenix homepage.”

The following paragraphs describe how the concept of bookmarks can be applied to wireless Web browsing using voice recognition to identify and select the desired bookmark, and hence to access the desired Web page or resource.

Initially, the bookmarks must be created and stored for future reference. Returning to FIG. 1 for a moment, database 15 is shown connected to speech server 8 and WAP server 10 by way of LAN 13. Database 15 is preferably a SQL compliant relational database, as is well known in the art, although any appropriately configured database is sufficient. Bookmarks are stored to database 15 in several ways. The simplest manner of storing bookmarks would be for a PC user to access a Web page served up by WAP server 10, which Web page provides text fields whereby a user can input a URI and an associated short cut phrase. In the preferred embodiment, each user of the system has an individual account. The bookmarks created by a user will be stored in a particular table in database 15 associated with that user. Alternatively, any user can access any bookmark stored to the system by any other user. In addition to creating new bookmarks, bookmarks can be edited, deleted, or renamed via WAP server 10.

Another way to input bookmarks is to dial into speech server directly over the public switched telephone network 6 or over the cellular service network and public switched telephone network, in the case of a cellular phone. As discussed in greater detail below, speech server 8 will recognize an incoming call and will provide a series of voice prompts to allow a user to select what services are desired. Among the services included are options to add, edit, or delete bookmarks for the user's account. The user can input a URI and an associated shortcut phrase vocally. In the former case, the spoken URI and shortcut will be converted to text using speech recognition engine 24. Finally, the bookmark service can also be accessed by dialing into speech server 8 using a wireless access device 2, via cellular service network 4, WAP gateway 7, and connecting via the Internet. Bookmarks could then be input using the data input capabilities of the cellular phone.

Once stored, the bookmarks can be access and the desired bookmark selected by calling into speech server 8 from cellular phone 2 and simply speaking the shortcut phrase for the desired URI. The following paragraphs describe alternative preferred methods for establishing a connection with the speech server.

In a first preferred embodiment, the end-user initiates access to speech server 8 by dialing the speech server's telephone number using wireless access device 2. The telephone number can be input manually using the device's numeric keypad, or may be stored in the devices memory and selected from a menu or list. Alternatively, the user might select an icon from a graphical user interface provided on the device, which icon has associated with it the telephone number for speech server 8.

Using the cellular service network 4 and the public switched telephone network 6, a voice connection is established between wireless access device 2 and speech server 8, by way of line interface card 20. Once the call is established, call manager 22 initiates and manages a call flow, which is a sequence of voice prompts (either prerecorded or generated by TTS engine 28), receives responses (which are recognized by speech recognition engine 24) and makes requests to other resources, such as calls to database 15. Call manager 22 is preferably a series of software instructions provided to the speech server hardware and to other program code running on the speech server or other computers on LAN 13, written in a programming language such as C or C++. Call manager 22 communicates with the other programs, such as TTS engine 28 and speech recognition 24, by sending socket calls and API calls to those programs.

Preferably, speech server 8 will indicate that the connection with wireless access device 2 has been established by providing the user with a pre-recorded voice prompt such as “Welcome to the wirenix.com Speechmarks™ service.” The user is preferably then asked to provide a user identification and/or password. The user's spoken responses will be passed by call manager 22 to speech recognition engine 24, where they will be converted to text and the result compared to a pre-stored user identification and password. Alternatively, the user could provide a single spoken phase which would be passed by call manager 22 to speech recognition engine 24, which would perform both a speech to text conversion to identify the user account; and a verification of the phrase, comparing it to a stored voice print and serving as verification of the user's identity. Alternatively, speech server 8 could receive the Mobile Identification Number (MIN) associated with wireless access device 2 automatically (essentially the wireless equivalent to Caller ID). In this way, the user will be automatically identified to the system, and a password for verification may or may not be required, depending upon the level of security desired.

Once identified, the user can request a specific bookmark (URI) by speaking the shortcut phrase associated with it. In addition, as discussed above, other options such as adding or modifying bookmarks will also be available. The spoken phrase is passed to speech recognition engine 24 where it is converted to a text phrase and compared to the recognizable text phrases in the user's grammar (the grammar is a file of expected words that the speech recognition engine will accept as valid words). If the phrase is not found in the grammar, an error will be generated that preferably results in a prompt requesting the user to repeat the shortcut. If the phrase is found as valid, speech recognition engine 24 returns a look-up value to call manager 22. This look-up value is used by call manager 22 to identify the appropriate entry in database 20 associated with the shortcut provided by the user. Call manager 22 then places an entry into a results table of database 20, which entry includes the database address of the identified database entry, along with identification information (such as UserID and SessionID) by which WAP server 10 can synchronize the data connection to cellular phone 2 with the URI identified in the results table by speech server 8.

Having located the desired URI, call manager 22 then terminates the voice call with wireless access device 2 and initiates a connection to WAP server 10 over LAN 13. In the preferred embodiments, speech server 8 establishes a network connection with WAP server 10 and initiate the request for WAP server to located the desired Web page. Included in the network connection message is sufficient identifying information, such as the UserID and SessionID, to allow WAP server 10 to identify the database address of the URI (bookmark) selected by the user. The database entry (which is the desired URI) at that address is retrieved by WAP server 10 using well known database calls and the Web page at that URI can then be served up to the wireless access device identified in the socket call from speech server 8 to WAP server 10. This requires that WAP server 10 initiate a data connection with wireless access device via WAP gateway 7 and cellular network 4. In an alternative, preferred embodiment, WAP server 10 initiates a data connection to wireless access device 2 and serves up a pre-formatted page, which page includes a link to the particular Web page selected by the user during the voice call to speech server 8. The user can then access the desired Web page by clicking on or otherwise selecting the link.

In a second preferred embodiment, access to speech server 8 can be established through a data connection to wireless access server 10, as follows. A user wishing to navigate the Web using pre-stored bookmarks accesses WAP 10 over a data connection by selecting an icon or by selecting the name of the wireless access server from a list provided on the display of device 2. WAP 10 is configured to serve up an introduction page whenever a connection is established, the page including a hyperlink associated with speech server 8.

When the user clicks on or otherwise selects the hyperlink, wireless access device 2 responds by initiating a voice connection with speech server 8 via cellular network 4 and public telephone network 6. This is because the hyperlink provides the necessary telephone number and instructions to initiate the call. The data communication will be paused while the voice communication is established.

Once the voice communication is established with speech server 8, a call flow is established as described above, resulting in a desired URI being identified and located in database 20, and a network communication method being made to WAP server 10 to retrieve the identified URI. At this point, speech server 8 terminates voice communication with wireless access device 2, thus allowing the data communication to resume. Once data communication is resumed, WAP 10 will serve up a next page to wireless access device 2. This next page will have included on it a link to the URI retrieved from database 20, as described above.

The end-user clicks on the hyperlink in order to access the desired resource. In this second preferred embodiment, the need for the wireless access server 10 to initiate a data call to the wireless access device 2 is avoided. This simpler approach may be preferred when the wireless access protocols do not contemplate or allow for a connection to be established by a server.

The foregoing disclosure and description of preferred embodiments of the invention are illustrative and explanatory thereof and various changes in the size, shape, materials, components, circuitry, wiring connections and contacts, as well as the details of the illustrated circuitry, construction and method of operation may be made without departing from the spirit of the invention which is described with particularity in the claims appended hereto. For instance, various of the described components are illustrated as software code running on general purpose computers. Alternatively, these components could be realized as hard-wired specialized purpose computers, or as firmware pre-programmed into the hardware. Various modifications, and variations on the described embodiments will be apparent to one skilled in the art and are contemplated within the inventive concept as well.

We claim:

1. A method of providing World Wide Web navigation to an end-user using a wireless access device, comprising:
initiating a data connection between the wireless access device and a wireless access server;
serving a Web page to the wireless access device over the data connection, the Web page including one or more hyper-links, one of said hyper-links linking to a pre-selected speech server;
in response to an end-user clicking on the one of said hyper-links, initiating a voice connection between the wireless access device and the pre-selected speech server;
providing an interactive voice response session over the voice connection between the speech server and the wireless access device, whereby voice prompts are provided to the end-user and the end-user's responses are provided back to the speech server;
performing a speech to text conversion on a user's spoken command, the converted command indicating a desired resource;
forwarding the converted command from the speech server to the wireless access server; and
serving the desired resource to the wireless access device over the data connection.

2. The method of claim 1 wherein the data connection between the wireless access device and the wireless access server is a wireless access protocol (WAP) connection.

3. The method of claim 1 wherein the user's spoken command is a shortcut associated with the uniform reference indicator of the desired resource.

4. The method of claim 1 wherein the wireless access device is a cellular telephone.

5. The method of claim 1 wherein the wireless access device is a personal digital assistant.

6. A method of providing World Wide Web navigation services to an end-user using a wireless access device comprising:
storing to a database at least one universal resource indicator (URI) and an associated shortcut phrase;
providing a speech server that is accessible to the wireless access device;
receiving a spoken command from an end-user;
converting the spoken command into a text command;
comparing the text command to the shortcut phrase stored in the database;
in response to a determination that the text command matches the stored shortcut phrase, providing the URI associated with the stored shortcut phrase to a wireless access server;
accessing the provided URI and sending the resource having the URI from the wireless access server to the wireless access device.

7. The method of claim 6 wherein the resource is a World Wide Web page.

8. The method of claim 6 wherein the wireless access device is a cellular telephone.

9. The method of claim 6 wherein the wireless access device is a personal digital assistant.

10. The method of claim 6 wherein the speech server and the wireless access device communicate using the public switch telephone network.

11. The method of claim 6 wherein the speech server and the wireless access device communicate using a cellular telephone switch.

12. The method of claim 6 wherein the wireless access server and the wireless access device communicate using wireless access protocol (WAP).

13. The method of claim 6 further comprising:
verifying the identify of a user based upon a spoken user identifier.

14. A system for voice driven navigation of a computer network, the computer network having a plurality of network resources, each such resource having associated with it a unique resource identifier, comprising:
a wireless access device;
a wireless switch configured to receive transmissions from the wireless access device and the forward the transmissions to a public switched telephone network;
a speech server coupled to the public switched telephone network, configured to receive voice commands contained in the transmissions from the wireless access device and to convert the voice commands into text commands;
the speech server being further configured to retrieve from a database a resource indicator matching the converted text command and to forward the retrieved resource indicator to a wireless access server;
the wireless access server coupled to the speech server, and being configured to retrieve the resource associated with the resource and to serve the resource to the wireless access device.

15. The system of claim 14 wherein the computer network is the Internet.

16. The system of claim 14 wherein the resource is a World Wide Web page.

17. The system of claim 14 wherein the resource is served to the wireless access device using wireless application protocol.

18. A speech server configured to provide voice driven access for navigation of a computer network, the computer network including a plurality of resources, each such resource having a network address associated with it, comprising:
a call manager coupled to a telephone network and configured to receive an incoming voice call initiated from a wireless calling device;
a speech to text converter coupled to the call manager, receiving as input a spoken phrase associated with a desired network address and converting the spoken phrase into a text command;
a comparator, coupled to the speech to text converter and configured to compare the text command to entries stored in a network address database;
a network connection coupled to the computer network and configured to forward a selected network address from the network address database to a computer network server, whereby the computer network server will serve up the resource associated with the selected network address to the wireless calling device.

19. The speech server of claim 18 wherein the computer network is the Internet.

20. The speech server of claim 18 wherein the resource is a World Wide Web page.
